(19) United States
(12) Patent Application Publication
(10) Pub. No.: US 2025/0282145 A1
(43) Pub. Date: Sep. 11, 2025

(54) LIQUID CONTAINER PRODUCTION METHOD, LIQUID CONTAINER, AND LIQUID EJECTION APPARATUS

(71) Applicant: CANON KABUSHIKI KAISHA, Tokyo (JP)

(72) Inventors: MASATOMO OJIMA, Saitama (JP); JUNICHIRO IRI, Kanagawa (JP)

(21) Appl. No.: 19/065,089

(22) Filed: Feb. 27, 2025

(30) Foreign Application Priority Data
Mar. 8, 2024 (JP) 2024-035821

(51) Int. Cl. B41J 2/175

(52) U.S. Cl. CPC B41J 2/17559; B41J 2/17513; B41J 2002/17516

(57) ABSTRACT

An object is to provide a liquid container production method capable of hindering the occurrence of wrinkles. The liquid container production method includes: inserting a spout into a bag in which a first film including a non-flat section and a flat second film are welded together; and welding the first film and the second film to the spout. In the welding, a projection provided to a welder presses the second film and the spout, thereby forming a pit at a welded portion where the second film and the spout are welded together.

### BACKGROUND

### Field of the Disclosure

The present disclosure relates to a liquid container production method, a liquid container, and a liquid ejection apparatus.

### Description of the Related Art

Japanese Patent Laid-Open No. 2009-172918 discloses a liquid container having a liquid outlet member (spout) welded to the mouth of a bag, and a production method for the liquid container. In the production method in Japanese Patent Laid-Open No. 2009-172918, the liquid outlet member is inserted into the bag from a mouth of the bag, a tip end surface of the liquid outlet member and an edge of the bag are aligned on the same line, and thereafter a weld portion of the liquid outlet member and the mouth of the bag are welded together. According to the production method in Japanese Patent Laid-Open No. 2009-172918, the liquid container in which the portion of the liquid outlet member excluding the tip end surface is enclosed inside the bag can be obtained, so that the amount of outside air entering the inside of the bag can be reduced.

### SUMMARY

In some liquid container production processes, two films are prepared and any one of these two films is provided with a non-flat section, including one or both of a pit and a projection, formed for a certain purpose. In this case, the film including the non-flat section and the film not including the non-flat section are welded together in a state where their positions are aligned to each other.

In some cases, the formation of the non-flat section makes the length of the film including the non-flat section shorter than the length of the film not including the non-flat section. In the case where the two films having the different lengths are welded together after their positional alignment, wrinkles may occur in a welded portion of the films. This occurrence of wrinkles may lead to an intrusion of outside air into the bag from outside. Nevertheless, Japanese Patent Laid-Open No. 2009-172918 does not describe anything for hindering the occurrence of wrinkles during film welding.

The present disclosure has an object to provide a liquid container production method capable of hindering the occurrence of wrinkles.

The present disclosure is a liquid container production method including: inserting a spout into a bag in which a first film including a non-flat section and a flat second film are welded together as so to be opposed to each other, the spout configured to deliver a liquid contained in the bag to outside; and welding the first film to the spout by use of a first welder and welding the second film to the spout by use of a second welder, wherein in the welding, a projection provided to the second welder presses the second film and the spout, thereby forming a pit at a welded portion where the second film and the spout are welded together.

Further features of the present disclosure will become apparent from the following description of exemplary embodiments with reference to the attached drawings.

### BRIEF DESCRIPTION OF THE DRAWINGS

FIG. 1 is a perspective view illustrating an example of a liquid ejection apparatus which is applicable to an embodiment;

FIG. 2A is a view illustrating an example of a liquid container which is applicable to the present embodiment;

FIG. 2B is a cross-sectional view taken along a IIB-IIB line in FIG. 2A;

FIG. 3 is a flowchart presenting a liquid container production method which is applicable to an embodiment;

FIG. 4 is a view for explaining one process in the production method;

FIG. 5 is a view for explaining one process in the production method;

FIG. 6 is a view for explaining one process in the production method;

FIG. 7 is a view for explaining one process in the production method;

FIG. 8A is a schematic plan view of a first welder horn and a second welder horn;

FIG. 8B is a cross-sectional plan view of a liquid container;

FIG. 9 is a view for explaining one process in the production method;

FIG. 10 is a view for explaining one process in the production method;

FIG. 11A is a view illustrating an example of a second welder horn usable in an embodiment;

FIG. 11B is a bottom view of a liquid container which is applicable to an embodiment;

FIG. 12A is a view illustrating an example of a second welder horn usable in an embodiment; and

FIG. 12B is a bottom view of a liquid container which is applicable to an embodiment.

### DESCRIPTION OF THE EMBODIMENTS

### First Embodiment

### <Liquid Ejection Apparatus 100>

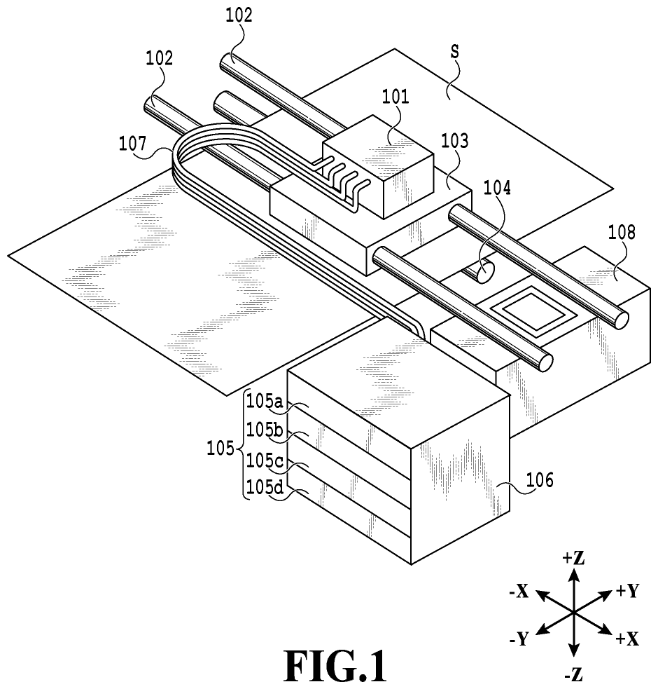

FIG. 1 is a perspective view illustrating an example of a liquid ejection apparatus 100 which is applicable to the present embodiment.

The liquid ejection apparatus 100 (for example, an inkjet printing apparatus) repeats reciprocating movement (main scanning in +X directions) of a liquid ejection head 101 and conveyance of a print sheet S as a print medium by a predetermined pitch (sub-scanning in a −Y direction). In synchronization with these operations, the liquid ejection apparatus 100 causes the liquid ejection head 101 to selectively eject multiple colors of liquids (for example, inks) to impact droplets of the liquids on the print sheet S as the print medium, thereby enabling formation of characters, symbols, an image or the like.

As the print medium, any medium may be used as long as an image can be formed on the medium by impacting ink droplets thereon. For example, it is possible to use print media made of various materials in various forms, such as paper, cloth, optical disk label surface, plastic sheet, OHP sheet, and envelop.

The liquid ejection head 101 is detachably mounted on a carriage 103 supported by two guide rails 102 in a slidable manner and configured to be reciprocated on a straight line along the guide rails 102 by a driving unit (not illustrated) such as a motor. The print sheet S that receives the liquids ejected from liquid ejection units of the liquid ejection head 101 is conveyed by a conveyor roller 104 serving as a conveyor unit in a direction intersecting the movement directions of the carriage 103 while facing a liquid ejection surface of the liquid ejection head 101. The liquid ejection head 101 includes, as multiple liquid ejection units, multiple nozzle arrays configured to eject different colors of liquids.

Multiple independent liquid container cases 105a to 105d for the respective colors of liquids to be ejected from the liquid ejection head 101 (for example, such as yellow, magenta, cyan, and black) are detachably attached to a liquid supply unit 106.

Hereinafter, the liquid container cases 105a to 105d will be simply referred to as the liquid container case 105 unless they have to be distinguished from each other in particular. The colors of liquids are not limited to the above four colors. Instead of the above four colors of liquids, three or less colors of liquids or five or more colors of liquids may be used.

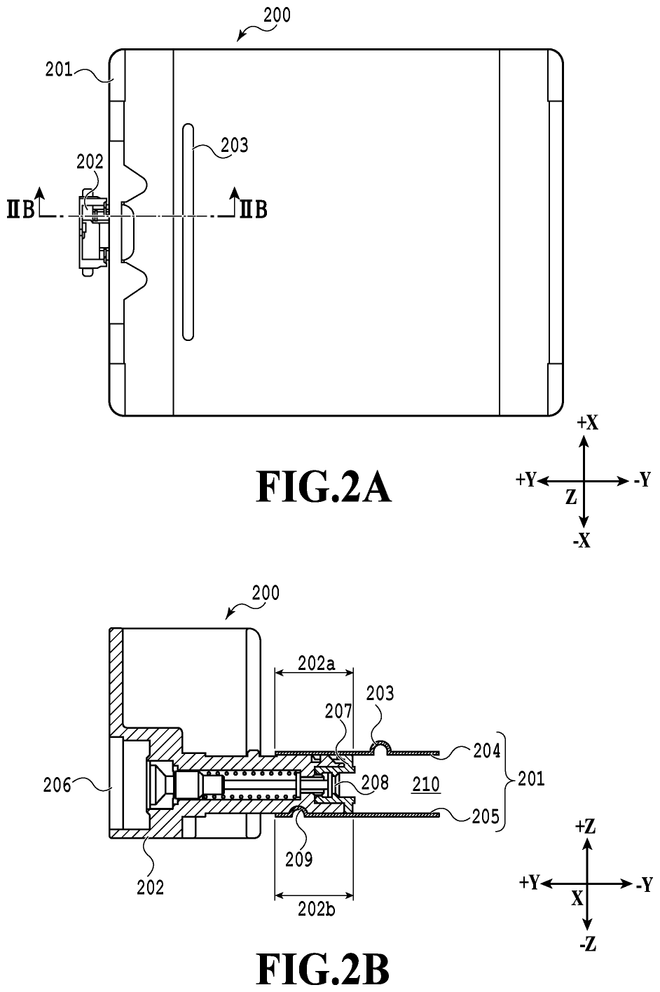

A liquid container 200 (see FIG. 2) capable of containing a liquid therein is housed in the liquid container case 105, and this will be described later.

The liquid supply unit 106 and the liquid ejection head 101 are connected to each other with multiple liquid supply tubes 107 dedicated for the respective colors of liquids. With the liquid container case 105 attached to the liquid supply unit 106, the respective colors of liquids stored in the liquid container case 105 are ready to be supplied to the respective nozzle arrays of the liquid ejection head 101 independently.

A recovery unit 108 is arranged so as to face the liquid ejection surface of the liquid ejection head 101 in a non-printing area, which is within a range of reciprocating movement of the liquid ejection head 101 and outside a range of passage of the print sheet S. The recovery unit 108 has a cap for capping the liquid ejection surface of the liquid ejection head 101, a suction mechanism for forcibly sucking the liquids from the liquid ejection head 101 with the liquid ejection surface capped, a cleaning blade for wiping off smear from the liquid ejection surface, and so on. The above suction operation is performed by the recovery unit 108 prior to a print operation by the liquid ejection apparatus 100.

Thus, even in a case where the liquid ejection apparatus 100 is operated after being left unused for a long period of time, the recovery process performed by the recovery unit 108 can remove residual air bubbles in the ejection units of the liquid ejection head 101, thickened liquids near the ejection orifices, and the like. As a result, the ejection characteristics of the liquid ejection head 101 are maintained.

### <Liquid Container 200>

FIG. 2A is a view illustrating an example of the liquid container 200 which is applicable to the present embodiment. In the drawings, X, Y, and Z directions indicate directions of the liquid container 200 housed in the liquid container case 105 (see FIG. 1).

As illustrated in FIG. 2A, the liquid container 200 mainly includes a bag 201 having flexibility and a spout 202 made of resin. Outer peripheries of multiple films are welded together, thereby forming the bag 201 is formed into a bag shape. The shape of the bag 201 is preferably a shape that can become nearly flat in a state where all the liquid is used up.

In the bag 201 in the present embodiment, a pitted or projected non-flat section 203 is formed only on a surface so as to store bubbles generated therein in a usage posture of the liquid container 200. The spout 202 is arranged at an end of the bag 201 and configured to be able to deliver the liquid contained in the bag 201 to outside. The spout 202 is made of, for example, a resin such as polypropylene or polyethylene.

FIG. 2B is a cross-sectional view taken along a IIB-IIB line in FIG. 2A.

As illustrated in FIG. 2B, the liquid container 200 includes a first film 204 including the non-flat section 203 having at least one of a pit and a projection and a second film 205 welded to the first film 204 so as to be opposed to the first film 204. The spout 202 is inserted into the bag 201 formed with the first film 204 and the second film 205 welded together. The spout 202 includes a first weld portion 202a for welding the first film 204 and a second weld portion 202b for welding the second film 205. In the second weld portion 202b, a pit 209 is formed. The pit 209 is formed on one side of the second weld portion 202b located between the center of the second weld portion 202b and an insertion opening through which the spout 202 is inserted.

In the present embodiment, the non-flat section 203 is a projected section. In the usage posture of the liquid container 200 (the posture where the −Z direction points to a gravity direction), the inside of the non-flat section 203 is hollow. The liquid container 200 is an ink pack mountable on an inkjet printing apparatus. The non-flat section 203 functions as a storage section to store bubbles generated inside the bag 201 in a state where the liquid container 200 is mounted on the inkjet printing apparatus. The spout 202 includes a supply port 206 configured to supply the liquid to outside and an outlet 207 which is located in the bag 201 at an innermost part in the spout 202 welded to the bag 201 and which is configured to deliver the liquid to the supply port 206.

In the present embodiment, the non-flat section 203 is formed in the bag 201 before the bag 201 and the spout 202 are welded together. On the other hand, the pit 209 is formed in the course of welding the second film 205 to the spout 202 in order to hinder the occurrence of wrinkles in the second film 205. In the course of welding the first film 204 including the non-flat section 203 and the flat second film 205 with the spout 202 interposed in between, wrinkles may occur in some cases due to a relative misalignment between the first film 204 and the second film 205. Such wrinkles tend to occur near the tip end of the second weld portion 202b, in particular. In the present embodiment, such wrinkles can be effectively hindered from occurring by forming the pit 209 near the tip end of the second weld portion 202b in the course of welding the second film 205 to the spout 202.

The pit 209 is preferably formed on a side farther from the outlet 207 out of two sides across the center of the second weld portion 202b. This is because, in the course of welding the second film 205 to the spout 202, a deformation of the second weld portion 202b is tolerable but a deformation of the outlet 207 is intolerable. For example, the pit 209 is preferably formed at a distance of 5 mm or longer from the outlet 207 in the +Y direction in FIG. 2B.

In addition, each of a length of the pit 209 from its opening to its deepest portion (the length in the Z direction) and a length of a short side of the opening of the pit 209 (the length in the Y direction) is 1.4 mm to 2.0 mm. The size of the pit 209 is not limited to the above example, as a matter of course.

As will be described in detail later, in the case where the length in the Z direction and the length in the Y direction of the pit 209 are set to 1.4 mm to 2.0 mm, wrinkles can be hindered from occurring in the course of forming the pit 209. However, the size of the pit 209 may be changed as needed according to the size of the liquid container 200 and the size and number of non-flat sections 203.

The structures of the first film 204 and the second film 205 are preferably structures each including an inner layer located inside the bag 201 and an outer layer located outside the bag 201 in a state where the bag 201 is formed. The outer layer of the first film 204 and the outer layer of the second film 205 preferably contain metal. For example, the outer layer of the first film 204 and the outer layer of the second film 205 preferably contain aluminum. This is because aluminum has a relatively low gas permeability and therefore improves the gas-barrier properties as compared with a case where the outer layer of the bag 201 contains no metal.

On the other hand, the inner layer of the first film 204 and the inner layer of the second film 205 preferably contain resin. For example, the inner layer of the first film 204 and the inner layer of the second film 205 preferably contain polypropylene or polyethylene. This is because polypropylene and polyethylene have liquid contact endurance.

The liquid contact endurance mentioned herein means that in a state where a material is in contact with a liquid, the material has properties of not being affected by the liquid (specifically, not hardening, not becoming embrittled, or not corroding) and not causing components contained in the material to dissolve in the liquid. Accordingly, the inner layer of the first film 204 and the inner layer of the second film 205 may contain a material other than polypropylene or polyethylene as long as they have the liquid contact endurance.

Moreover, in a case where the same type of resin is used as the materials constituting the first weld portion 202a of the spout 202 and the inner layer of the first film 204 and the materials constituting the second weld portion 202b of the spout 202 and the inner layer of the second film 205, their melting points can be equalized, which additionally improves the weldability.

For example, the first weld portion 202a and the second weld portion 202b are assumed to be made of polypropylene. In this case, if the inner layer of the first film 204 and the inner layer of the second film 205 are also made of polypropylene, stronger sealing properties can be obtained than in a case where these are made of different materials.

Here, in a case where the first weld portion 202a and the second weld portion 202b are made of polyethylene, it is preferable that the inner layer of the first film 204 and the inner layer of the second film 205 be made of polyethylene.

Although the present embodiment is described on the assumption that the first film 204 and the second film 205 have a double layer structure including the inner layer and the outer layer, the first film 204 and the second film 205 may have a single-layer structure or have three or more layers.

In addition, the spout 202 includes the supply port 206 configured to supply the liquid contained in the bag 201 to the liquid ejection apparatus 100. A check valve 208 is disposed inside the outlet 207 in order to hinder backflow of the liquid and intrusion of air from the outside.

A majority of the bag 201 is constituted by a liquid container section 210 capable of containing the liquid (for example, an ink or the like). The liquid ejection apparatus 100 (see FIG. 1) includes a negative pressure generation mechanism (for example, a pump not illustrated) capable of sucking the liquid contained in the liquid container section 210 of the liquid container 200. With the negative pressure generated by sucking with this pump, the liquid contained in the liquid container section 210 is sucked by the liquid ejection apparatus 100.

It is preferable that the bag 201 be squeezed to as close to a flat shape as possible in a state where the liquid is sucked and used up. However, if the bag 201 near the spout 202 is completely squeezed while the liquid remains in the liquid container section 210, it will be difficult to use up all of the liquid remaining behind the squeezed portion. To address this, in the first film 204 in the present embodiment, the projected non-flat section 203 is formed, the inside of which is hollow in the usage posture of the liquid container 200.

With this structure, even if the bag 201 is completely squeezed, the non-flat section 203 remains unsqueezed and allows air to stay in the non-flat section 203 in the usage posture of the liquid container 200, which makes it possible to continue suctioning the liquid. Thus, the existence of the non-flat section 203 improves the ease of using up the liquid compared to a case in which the non-flat section 203 does not exist.

### <Production Method of Liquid Container 200>

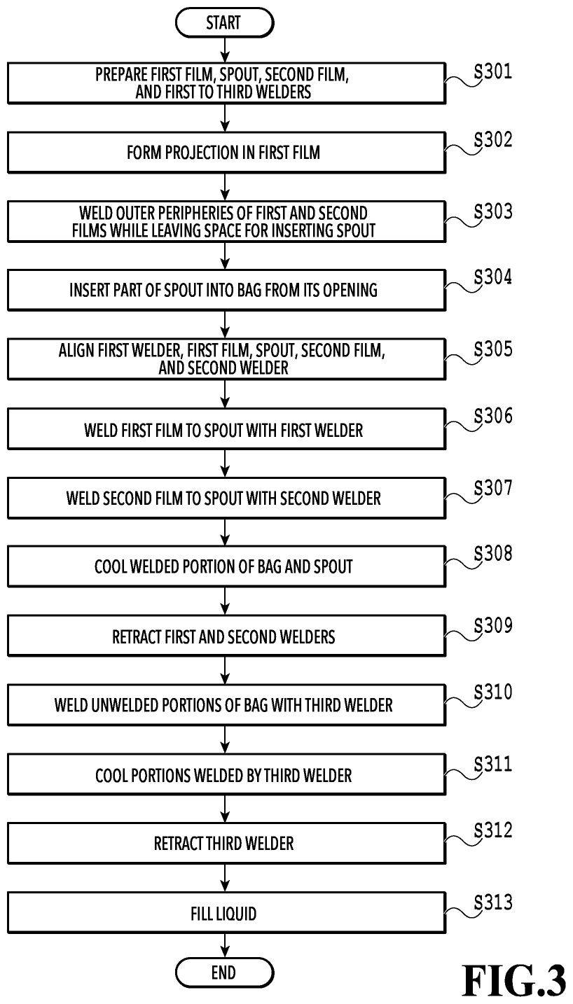

FIG. 3 is a flowchart presenting a production method of the liquid container 200 (see FIG. 2A or others), which is applicable to the present embodiment. Here, sign “S” in description of each process indicates a step in the flowchart.

In S301, the first film 204, the spout 202, and the second film 205, which are not illustrated in FIG. 3, and a first welder, a second welder, and a third welder (not illustrated) are prepared. At this time point, the size of the first film 204 and the size of the second film 205 are the same.

In S302, the non-flat section 203 (see FIG. 2A or others) is formed in the first film 204. For example, the first film 204 is heated and the heated part is sucked, so that the non-flat section 203 in a projected shape is formed. Due to the formation of the non-flat section 203, the first film 204 is stretched and therefore may have a shorter length or a larger surface area than the second film 205 has.

In S303, the first film 204 and the second film 205 are put together, and the outer peripheries of the first film 204 and the second film 205 are welded together using the welders (not illustrated), leaving a space for inserting the spout 202.

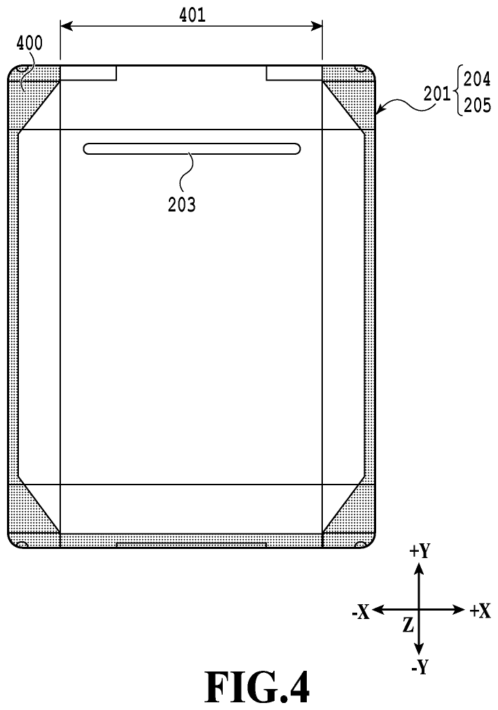

FIG. 4 is a view for explaining S303 (see FIG. 3).

As illustrated in FIG. 4, in S303, the outer peripheries of the first film 204 and the second film 205 are welded together at an edge portion 400 on three consecutive sides. Thus, the bag 201 is formed which includes an insertion opening 401 for inserting the spout 202 (not illustrated in FIG. 4). In reference to FIG. 3 again, the production method in the present embodiment will be described below.

In S304, the insertion opening 401 (see FIG. 4) of the bag 201 (see FIG. 2A or others) is opened and a part of the spout 202 (see FIG. 2A or others) is inserted into the bag 201 through the insertion opening 401.

In S305, the bag 201 into which the spout 202 is inserted and the welders are aligned with each other.

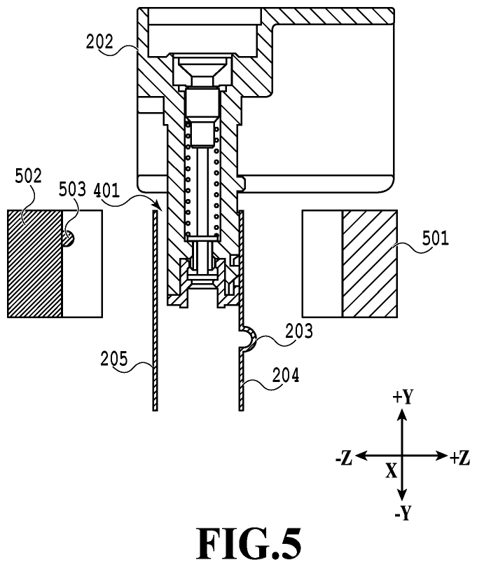

FIG. 5 is a view for explaining S305. In FIGS. 5 to 7 and 9, the X direction, the Y direction, and the Z direction are orthogonal to each other. The +Y direction indicates an anti-gravity direction, and the −Y direction indicates a gravity direction. The X direction and the Z direction indicate two directions orthogonal to each other on a horizontal plane. In FIGS. 5 to 7 and 9, the X direction indicates a depth direction of the liquid container 200 in the middle of production, the Y direction indicates a height direction of the liquid container 200 in the middle of production, and the Z direction indicates a width direction of the liquid container 200 in the middle of production.

In a state where the liquid container 200 is mounted on the liquid ejection apparatus 100, the −Z direction is the gravity direction, the +Z direction is the anti-gravity direction, the +Y direction points to the front, the −Y direction points to the rear, the −X direction points to the left, and the +X direction points to the right. In other words, in the state where the liquid container 200 is mounted on the liquid ejection apparatus 100, the X direction is a short-side direction of the liquid container 200, the Y direction is a longitudinal direction of the liquid container 200, and the Z direction is a height direction of the liquid container 200.

As illustrated in FIG. 5, the welders used in the present embodiment include the first welder and the second welder. In the positional alignment in S305, an upper end of the first film 204 including the non-flat section 203 may be displaced in the −Y direction from an upper end of the second film 205 having the flat shape in some cases.

In the present embodiment, a first welder horn 501 is used as the first welder and a second welder horn 502 is used as the second welder. In the second welder horn 502, a projection 503 for pressing the second film 205 and the spout 202 is formed.

In S306, the first film 204 is welded to the spout 202 by use of the first welder horn 501.

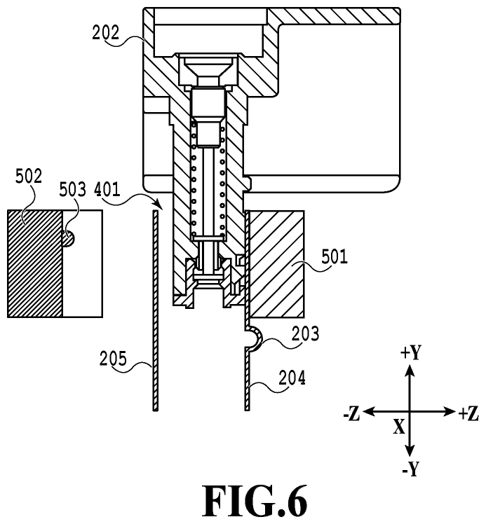

FIG. 6 is a view for explaining S306.

As illustrated in FIG. 6, the first welder horn 501 is advanced toward the first film 204 and the spout 202 to weld the first film 204 to the spout 202. In reference to FIG. 3 again, the production method in the present embodiment will be described below.

In S307, the second film 205 is welded to the spout 202 by use of the second welder horn 502.

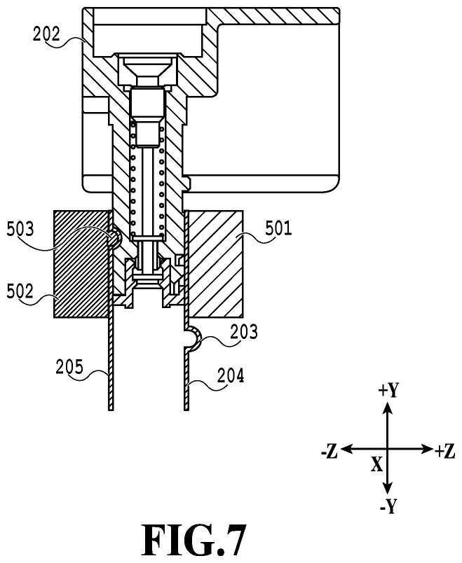

FIG. 7 is a view for explaining S307.

As illustrated in FIG. 7, in S307, the second welder horn 502 is advanced toward the second film 205 and the spout 202 with the first welder horn 501 pressed against the first weld portion 202a (not illustrated in FIG. 7). Then, the second film 205 is welded to the spout 202 by use of the second welder horn 502.

At a time when S307 is performed, the length of the first film 204 in the longitudinal direction in FIG. 7 may be shorter than its original length due to the formation of the non-flat section 203 in the first film 204 as described above. In other words, in some cases, the upper end of the first film 204 may be located at a lower level than the upper end of the second film 205 is. If the process of welding the bag 201 and the spout 202 is performed in that state, the upper end of the second film 205 may be pulled more than necessary and wrinkles may occur in the second film 205.

To address this, in the present embodiment, the welding is performed while the second film 205 is being pressed from the outside to the inside of the spout 202 by using the projection 503 of the second welder horn 502. According to this method, the second film 205 can be welded to the spout 202 while the second film 205 is ingrowing the spout 202 with tension being applied to the second film 205. To put it differently, since the tension is being applied to the second film 205 during the welding in S307, even if wrinkles occur in the second film 205, the wrinkles can be stretched out and eliminated.

Such wrinkles tend to occur near the tip end of the second film 205 (in other words, near the insertion opening 401 (see FIG. 4)). Accordingly, in order to effectively eliminate wrinkles that occur near the tip end of the second film 205, it is preferable that the projection 503 be located near the tip end of the second film 205 during the welding in S307.

For example, the projection 503 is preferably formed at a position within a range of ½ of the length from a tip end (the end on the +Y direction side) to the other end (the end on the −Y direction side) of the second welder horn 502, the range ranging from the tip end toward the other end of the second welder horn 502. With this structure, since the projection 503 can be located near the tip end of the second film 205 during the welding in S307, it is possible to effectively hinder wrinkles from occurring near the tip end of the second film 205. In addition, as illustrated in FIG. 7, the height level of the tip end of the second film 205 can be made close to the height level of the tip end of the first film 204.

Here, it is preferable that the lengths of the projection 503 in the Y direction and the Z direction be within a range of 1.4 mm to 2.0 mm. This is because, if the length of the projection 503 in the Y direction is too long relative to its length in the Z direction, the projection 503 may pull down the tip end of the second film 205 too much during the welding, which may actually cause wrinkles. For example, in a case where the length of the projection 503 in the Y direction is 4 mm, the length of the projection 503 in the Z direction is preferably about 0.7 mm. With this structure, it is possible to keep a moderate displacement of the tip end of the second film 205 during the welding.

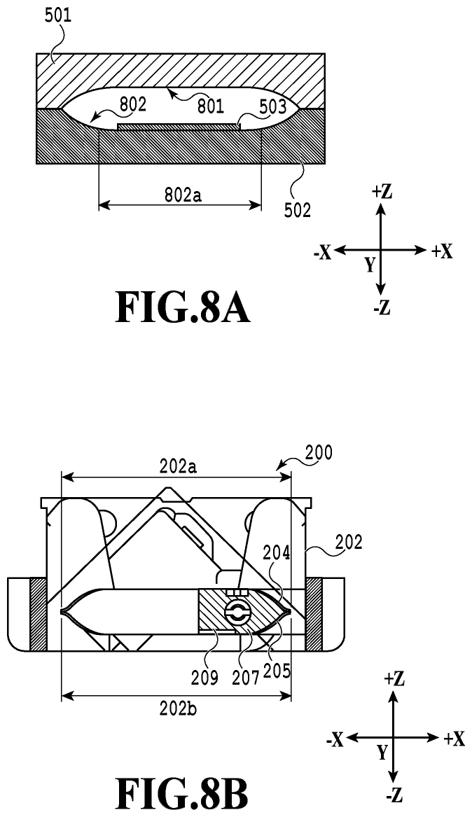

FIG. 8A is a schematic cross-sectional view of the first welder horn 501 and the second welder horn 502.

FIG. 8B is a schematic cross-sectional plan view of the liquid container 200.

As illustrated in FIGS. 8A and 8B, the first welder horn 501 includes a recess 801 corresponding to a shape of the first weld portion 202a of the spout 202. The second welder horn 502 includes a recess 802 corresponding to a shape of the second weld portion 202b of the spout 202. A deepest portion 802a of the recess 802 is in a flat shape corresponding to a flat portion of the second weld portion 202b. Two sides across the deepest portion 802a are curved so as to correspond to curved portions of the second weld portion 202b.

In the second welder horn 502, the projection 503 projects from the deepest portion 802a toward an opening of the recess 802. The length of the projection 503 in the X direction is preferably within a range of ½ or more to less than ⅔ of the length of the deepest portion 802a in the X direction. If the length of the projection 503 in the X direction is less than ½ of the length of the deepest portion 802a in the X direction, the amount of the projection 503 ingrowing the second weld portion 202b is insufficient, making it difficult to hinder wrinkles during the welding.

On the other hand, if the length of the projection 503 in the X direction is equal to or more than ⅔ of the length of the deepest portion 802a in the X direction, the projection 503 may interfere with the curved portions of the second weld portion 202b, resulting in a lack of the stability of the welding.

For example, if the length of the projection 503 in the Z direction is 1 mm or less, the amount of the second film 205 pressed toward the inside of the spout 202 is insufficient, making it difficult to expect any wrinkle-eliminating effect.

If the length of the projection 503 in the Z direction is 3 mm or more, the amount of the spout 202 deformed is too large, which may damage the outlet 207. With these viewpoints taken into consideration, it is preferable that the length of the projection 503 in the Z direction be within a range of 1.4 mm to 2.0 mm as described above. However, the design for the above size of the projection 503 may be changed as needed according to the size of the spout 202 (in other words, the capacity of the liquid container or the like).

In reference to FIG. 3 again, the production method in the present embodiment will be described below.

In S308, the welded portion of the bag 201 and the spout 202 (the first weld portion 202a and the second weld portion 202b not illustrated in FIG. 3) is cooled. For example, while the welded portion is supported by the welder, the operation of the welder horn is stopped and then the welded portion is left for a predetermined period of time.

In S309, the first welder horn 501 and the second welder horn 502 are retracted from the bag 201.

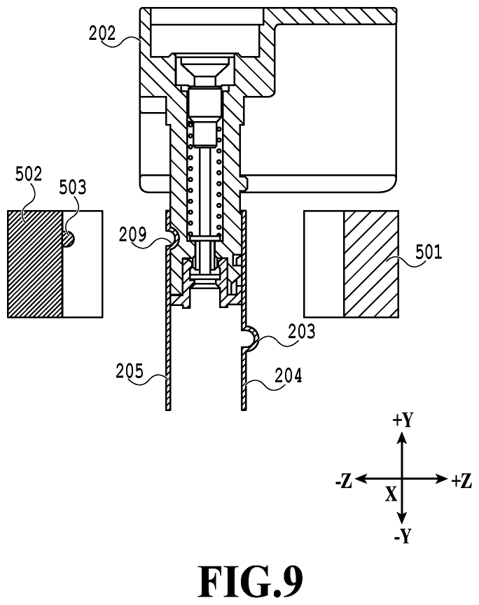

FIG. 9 is a view for explaining S309.

As illustrated in FIG. 9, in S309, as the projection 503 of the second welder horn 502 is separated from the second weld portion 202b, the pit 209 is formed at the portion having been pressed by the projection 503. Here, return to FIG. 3 again for reference.

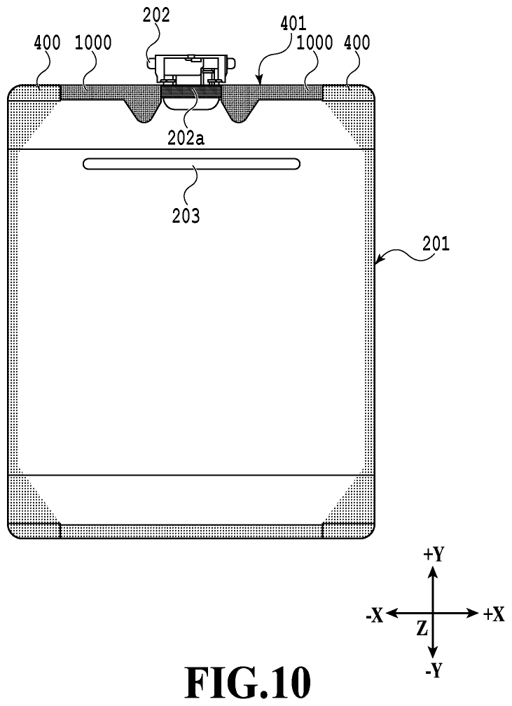

In S310, unwelded portions 1000 of the bag 201 (see FIG. 10) are welded by use of the third welder (for example, a third welder horn not illustrated).

FIG. 10 is a view for explaining S310.

As illustrated in FIG. 10, in S310, the unwelded portions 1000 of the bag 201 are welded by use of the third welder.

In the present embodiment, first, the relatively large insertion opening 401 is formed, the spout 202 is inserted into the insertion opening 401, the spout 202 is welded to a center portion of the insertion opening 401, and then the unwelded portions 1000 of the insertion opening 401 are welded. According to this method, since the spout 202 can be inserted into the relatively large insertion opening 401, the positional alignment of the spout 202 is easier than in a method including first welding both end portions of the insertion opening 401 and then inserting the spout 202 into the center portion of the insertion opening 401.

In addition, unlike a method including inserting the spout 202 into the insertion opening 401, welding both end portions of the insertion opening 401, and then welding the center portion of the insertion opening 401, the welding of the portion most tending to wrinkle can be first completed, and in that state, the remaining unwelded portions can be welded. Thus, the occurrence of wrinkles can be hindered over the entire area of the liquid container 200 in the width direction (X direction). Here, return to FIG. 3 again for reference.

In S311, the welded portion of the bag 201 and the spout 202 is cooled.

In S312, the third welder is retracted from the bag 201.

Through the above processes, the liquid container in the present embodiment is completed. After that, a predetermined liquid is filled in the bag 201 through the spout 202, so that the liquid container (ink pack) usable in a liquid ejection apparatus is obtained.

As described above, in the present embodiment, a part of the spout is inserted into the bag including the first film having the non-flat section and the flat second film from the insertion opening of the bag, and then the second film is welded to the spout while their second film sides are being deformed. This reduces a misalignment between the first film and the second film in the −Y direction, making it possible to hinder wrinkles from occurring due to the welding.

During the welding, the second film is pressed by the projection of the welder horn, so that the pit ingrowing the spout is formed in the second film. Since the second film is stretched by the amount of the pit formed, making it possible to reduce the size difference between the first film in which the non-flat section has been formed in advance, and the second film which has been flat. That is, two films in approximately the same size are welded to one spout, so wrinkles are less likely to occur, and even if wrinkles do occur, they can be expected to be eliminated.

Therefore, according to the production method in the present disclosure, it is possible to hinder wrinkles from occurring in the welded portion of the bag.

### Second Embodiment

Hereinafter, a second embodiment of the technique of the present disclosure will be described in reference to the drawings. The present embodiment has an object to provide a liquid container having superior sealing properties. In the following description, different points from those in the first embodiment will be mainly described while the constituents same as or corresponding to those in the first embodiment will be denoted with the same reference signs, and description thereof will be omitted.

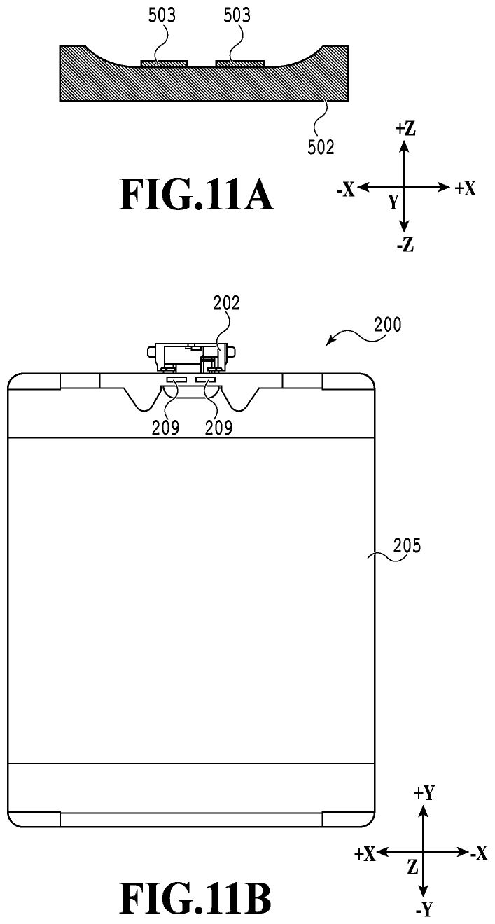

FIG. 11A is a view illustrating an example of a second welder horn 502 usable in the present embodiment.

As illustrated in FIG. 11A, the second welder horn 502 in the present embodiment includes two projections 503 arranged along the X direction. The welding process in the present embodiment (see S307 in FIG. 3) uses the second welder horn 502 including these two projections 503.

FIG. 11B is a bottom view of the liquid container 200 which is applicable to the present embodiment. In FIG. 11B, the liquid container 200 is presented in a state where the liquid container 200 is mounted on the liquid ejection apparatus 100 (see FIG. 1).

As illustrated in FIG. 11B, in the liquid container 200 in the present embodiment, two pits 209 corresponding to the above two projections 503 (see FIG. 11A) are formed at a portion corresponding to the second weld portion 202b (see FIG. 2B or others).

The second film 205 is deformed in the pitted shape in the welding process (see S307 in FIG. 3). For this reason, if this welding is insufficient, the second film 205 may peel off from the spout 202 due to a resilient restoring force of the second film 205. For example, if the cooling in the cooling process (see S308 in FIG. 3) is insufficient, in S309 (see FIG. 3) the second film 205 may peel off in the course of retracting the second welder horn 502 (see FIG. 9 or others) from the bag 201.

In the present embodiment, the two pits 209, which are each smaller than the pit 209 in the first embodiment, are formed, so that the resilient restoring force of the second film 205 acting at the second weld portion 202b is dispersed to be smaller than in the first embodiment. Accordingly, the sealing properties in the second weld portion 202b are improved as compared with the first embodiment.

Thus, according to the production method in the second embodiment, it is possible to provide a liquid container having superior sealing properties.

### [Variation of Second Embodiment]

Hereinafter, a variation of the second embodiment will be described in reference to the drawings.

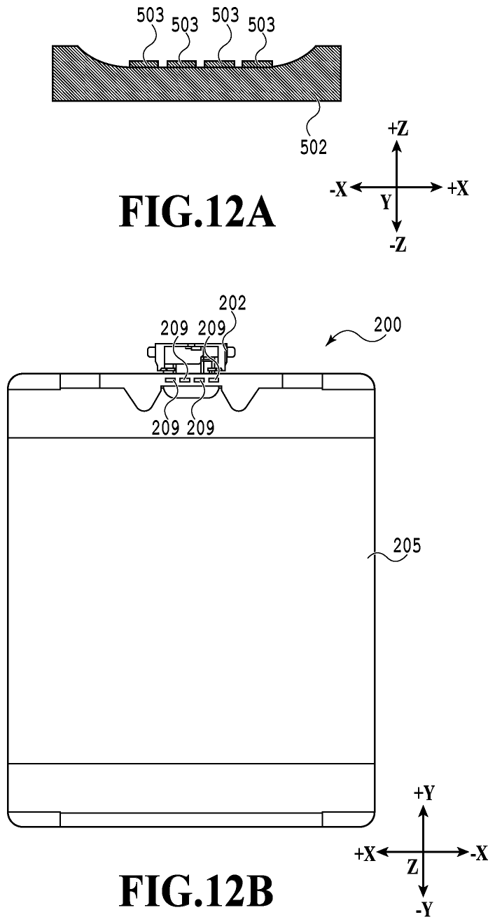

FIG. 12A is a view illustrating an example of a second welder horn 502 usable in the present variation.

As illustrated in FIG. 12A, the second welder horn 502 in the present variation includes four projections 503 arranged along the X direction. The welding process (see S307 in FIG. 3) in the present variation uses the second welder horn 502 including these four projections 503.

FIG. 12B is a bottom view of the liquid container 200 which is applicable to the present variation. In FIG. 12B, the liquid container 200 is presented in a state where the liquid container 200 is mounted on the liquid ejection apparatus 100 (see FIG. 1).

As illustrated in FIG. 12B, four pits 209 corresponding to the above four projections 503 (see FIG. 11A) are formed in the second weld portion 202b (see FIG. 2 or others) in the present variation. It should be noted that the number of pits 209 is not limited to two or four as long as there are multiple pits. The direction along which multiple pits 209 are formed is not limited to the X direction. For example, multiple pits 209 may be formed along the Y direction.

In the present variation, the four pits 209, which are each smaller than the pit 209 illustrated in FIG. 11, are formed, so that the resilient restoring force of the second film 205 acting at the second weld portion 202b is more dispersed to be much smaller than in the example of FIG. 11. Accordingly, the sealing properties in the second weld portion 202b are improved as compared with the example of FIG. 11.

Thus, according to the production method in the present variation, it is possible to provide a liquid container having sealing properties superior to those of the example in FIG. 11.

As described above, the size and number of projections 503 may be changed variously according to the sizes and shapes of the liquid container and the spout.

### OTHER EMBODIMENTS

In the above embodiments, the inks are used as the liquids, but a liquid usable in the technique of the present disclosure is not limited to an ink. As the liquid, various printing solutions other than the ink may be used, such as treatment solutions to be used for the purposes of improving fixing properties, reducing glossy unevenness, or improving rubfastness of the ink on a printing medium.

The processes presented in FIG. 3 may be arranged in a different sequence, or one or some of them may be omitted. As a matter of course, two or more of the processes may be performed simultaneously. In the above embodiments, in particular, the welding process of the first film and the welding process of the second film are performed individually. However, these processes may be performed entirely or partially simultaneously. If the second film can be welded to the spout while being pressed from the outside toward the inside of the spout by use of the projection of the second welder horn, the relative misalignment between the first film and the second film can be reduced to hinder the occurrence of wrinkles. Although the mode where the formation of the bag 201 and the welding of the spout are performed as a series of processes is described in reference to FIG. 3, the present invention is not limited to this. The production method may include preparing a bag and a spout produced in advance and performing only the processes in S304 and the subsequent steps.

Although the above embodiments use a pillow-type three-sided bag as the bag, a gusseted-type bag having a gusset or other type of bags may be used instead. In this case, gussets are provided to both of right and left films welded between the first film and the second film. Instead, a gusset may be provided to a bottom film welded at a position opposed to the spout between the first film and the second film. In these cases, the spout is inserted into the bag including the gusset provided between the first film and the second film.

According to the production method disclosed herein, it is possible to hinder the occurrence of wrinkles in a welded portion of a bag.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-035821, filed Mar. 8, 2024, which is hereby incorporated by reference wherein in its entirety.

What is claimed is:

1. A liquid container production method comprising:
inserting a spout into a bag in which a first film including a non-flat section and a flat second film are welded together as so to be opposed to each other, the spout configured to deliver a liquid contained in the bag to outside; and
welding the first film to the spout by use of a first welder and welding the second film to the spout by use of a second welder, wherein
in the welding, a projection provided to the second welder presses the second film and the spout, thereby forming a pit at a welded portion where the second film and the spout are welded together.

2. The production method according to claim 1, wherein in the welding, the second film is welded after the first film is welded.

3. The production method according to claim 1, further comprising forming the bag by welding a part of an outer periphery of the first film and a part of an outer periphery of the second film together.

4. The production method according to claim 1, wherein the pit is formed on one side of the welded portion located between a center of the welded portion and an insertion opening through which the spout is inserted.

5. The production method according to claim 4, wherein
the spout includes a supply port configured to supply the liquid to the outside, and an outlet which is located in the bag at an innermost part in the spout welded to the bag and which is configured to deliver the liquid to the supply port, and
the pit is formed at a distance of 5 mm or longer from the outlet.

6. The production method according to claim 1, wherein each of a depth of the pit from its opening to its deepest portion and a length of a shot side of the opening of the pit is 1.4 mm to 2.0 mm.

7. The production method according to claim 1, wherein
the second welder is provided with a plurality of the projections,
in the welding, the pits are formed at positions corresponding to the plurality of projections.

8. The production method according to claim 1, wherein the bag is a three-sided bag.

9. The production method according to claim 1, wherein, in the welding, the spout is inserted into the bag having a gusset provided between the first film and the second film.

10. The production method according to claim 1, wherein a material constituting an outer layer of the first film and an outer layer of the second film is a metal.

11. The production method according to claim 10, wherein the material constituting the outer layer of the first film and the outer layer of the second film is aluminum.

12. The production method according to claim 1, wherein a material constituting the spout, an inner layer of the first film, and an inner layer of the second film is a same type of resin.

13. The production method according to claim 12, wherein the material constituting the spout, the inner layer of the first film, and the inner layer of the second film is polypropylene or polyethylene.

14. The production method according to claim 1, wherein
the liquid container is an ink pack mountable on an inkjet printing apparatus, and
the non-flat section is a projected section configured to function as a storage section to store a bubble generated inside the bag in a state where the liquid container is mounted on the inkjet printing apparatus.

15. A liquid container comprising:
a first film including a non-flat section;
a second film welded to the first film so as to be opposed to the first film;
a spout inserted into a bag in which the first film and the second film are welded together and configured to deliver a liquid stored in the bag to outside, wherein
a pit is formed at a welded portion where the second film and the spout are welded together.

16. The liquid container according to claim 15, wherein
the non-flat section is a projected section, and
an inside of the non-flat section is hollow in a usage posture.

17. The liquid container according to claim 15, wherein
the liquid container is an ink pack mountable on an inkjet printing apparatus, and
the non-flat section is a projected section configured to function as a storage section to store a bubble generated inside the bag in a state where the liquid container is mounted on the inkjet printing apparatus.

18. The liquid container according to claim 15, wherein the pit is formed on one side of the welded portion located between a center of the welded portion and an insertion opening through which the spout is inserted.

19. The liquid container according to claim 18, wherein
the spout includes a supply port configured to supply a liquid to outside, and an outlet which is located in the bag at an innermost part in the spout welded to the bag and which is configured to deliver the liquid to the supply port, and
the pit is formed at a distance of 5 mm or longer from the outlet.

20. A liquid ejection apparatus comprising:
a liquid container including a first film including a non-flat section, a second film welded to the first film so as to be opposed to the first film, and a spout inserted into a bag in which the first film and the second film are welded together, and configured to deliver a liquid stored in the bag to outside; and
a liquid ejection head configured to eject the ink supplied from the liquid container, wherein
a pit is formed at a welded portion where the second film and the spout are welded together.
